(19) United States
(12) Patent Application Publication
(10) Pub. No.: US 2022/0101424 A1
(43) Pub. Date: Mar. 31, 2022

(54) Computer implemented method and system for conducting escrow controlled reverse-auction transactions on the Internet

(71) Applicant: Evan Williams, Mission (CA)

(72) Inventor: Evan Williams, Mission (CA)

(21) Appl. No.: 16/392,173

(22) Filed: Apr. 23, 2019

(51) Int. Cl. G06Q 30/08; G06Q 30/06

(52) U.S. Cl. CPC G06Q 30/08; G06Q 30/0611; G06Q 30/0617

(57) ABSTRACT

My invention is a computer implemented system for conducting escrow controlled reverse-auction eCommerce transactions for a membership group on the Internet. Firstly, my invention greatly increases the safety of eCommerce transactions by the automated escrow control of the Buyer's money, whereby the Buyer's funds are held by the system and not released until the purchased item is received in ‘As Described’ conditions; Secondly, my invention determines the price of the item for sale by first displaying the item in an eShowcase at a fixed price for a chosen length of time and then lowering the price, in a reverse auction, until an accredited member decides to buy, where upon the automated escrow system takes over. The entire process of enrolling and vetting buyers and sellers (members), information exchange between the system and its members, money management via escrow and the variable item price control is a fully integrated software apparatus that runs on a stand-alone basis.

### BRIEF DESCRIPTION OF THE DRAWINGS

FIG. 1 is a logic flow diagram (general arrangement) of one example of the disclosed method and system.

FIG. 2 is a logic flow diagram (membership & item control) of one example of the disclosed method and system.

FIG. 3 is a logic flow diagram (item price count down control) of one example of the disclosed method and system.

FIG. 4 is a logic flow diagram (escrow payment control) of one example of the disclosed method and system.

### DETAILED DESCRIPTION

Methods and apparatus for a system for facilitating electronic commerce transactions for a private membership group of buyers and sellers using a first data storage location for holding information about an item for sale by an abating price evolvement (SAPE) process from a first participant in a data packet network, a verification process that verifies the user's membership identification as the first participant in said data packet network, the verification process confirming a user identification before allowing the participant in said data packet network access to place information about an item for sale by said SAPE process in the system, a display process for displaying information of the item for sale by said SAPE process to a plurality of private membership data packet network users, the display process displaying an advertisement with the item for sale by said SAPE process to the plurality of said private members data packet users, a process for receiving a bid on the item for sale by said SAPE process from at least one of said plurality of private members data packet network users, the said SAPE process also verifying a user's identification from said plurality of private members data packet network users before allowing receipt of the bid and a notification process for notifying the plurality of private members data packet network participants that said bid was accepted by said system, an escrow system that facilitates financial control of payments between said private members, said escrow system being integrated within the central apparatus of said electronic commerce system so as to ensure member satisfaction of goods received prior to release of funds to seller.

Definition: SAPE—Sale by Abating Price Evolvement

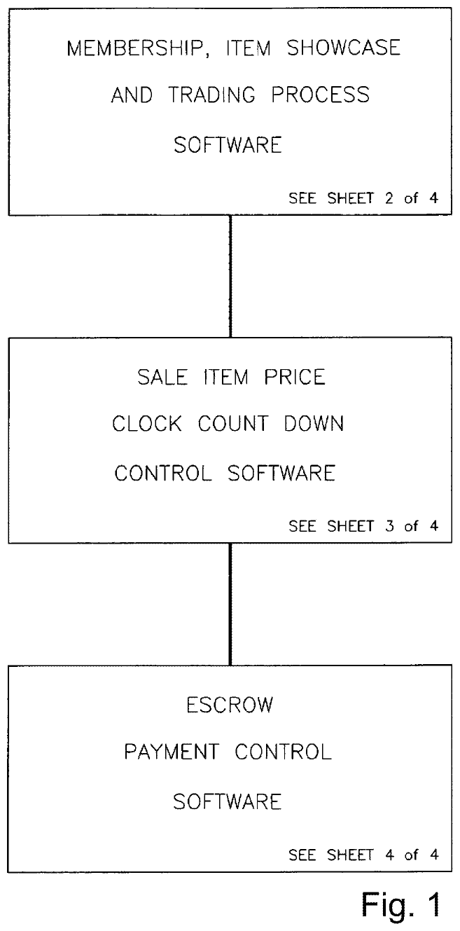

FIG. 1—(CDM-LD1 Sheet 1 of 4) is a Logic Flow Diagram—General Arrangement

This drawing shows graphically the three main sub-routines of the system that are to be detailed in the remaining three sheets of the drawing set. These three sub-routines together contain the entirety of the system.

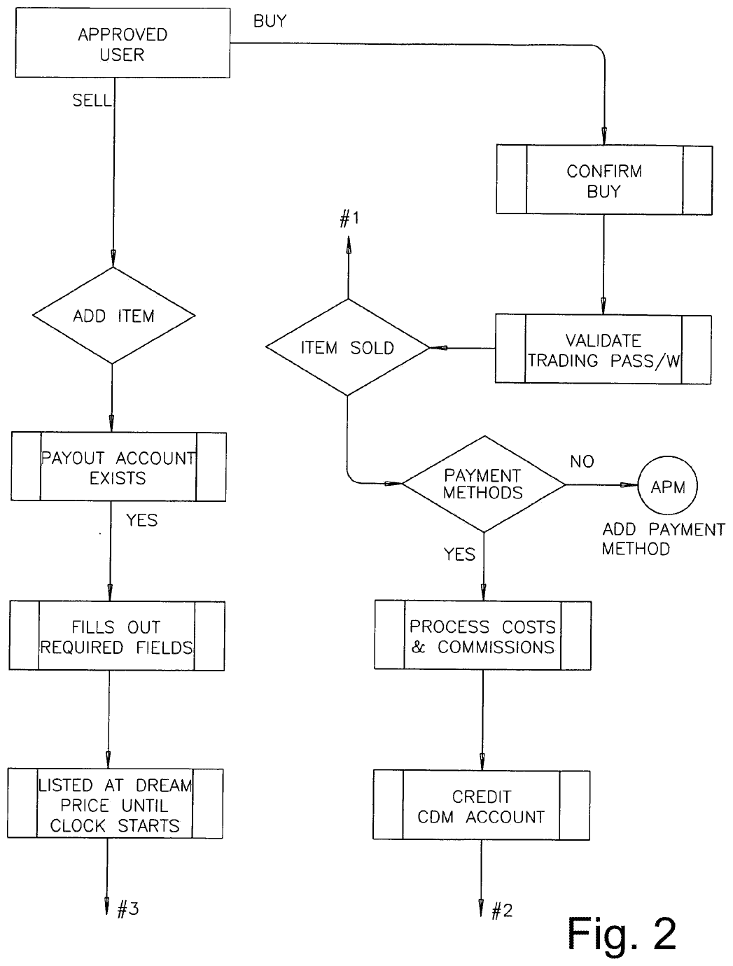

FIG. 2—(CDM-LD1 Sheet 2 of 4) is a Logic Flow Diagram—Membership & Item Control

This drawing depicts the membership and item control processes. These processes are automated and fully integrated into the overall system. Written in Python in a Django server-side web framework.

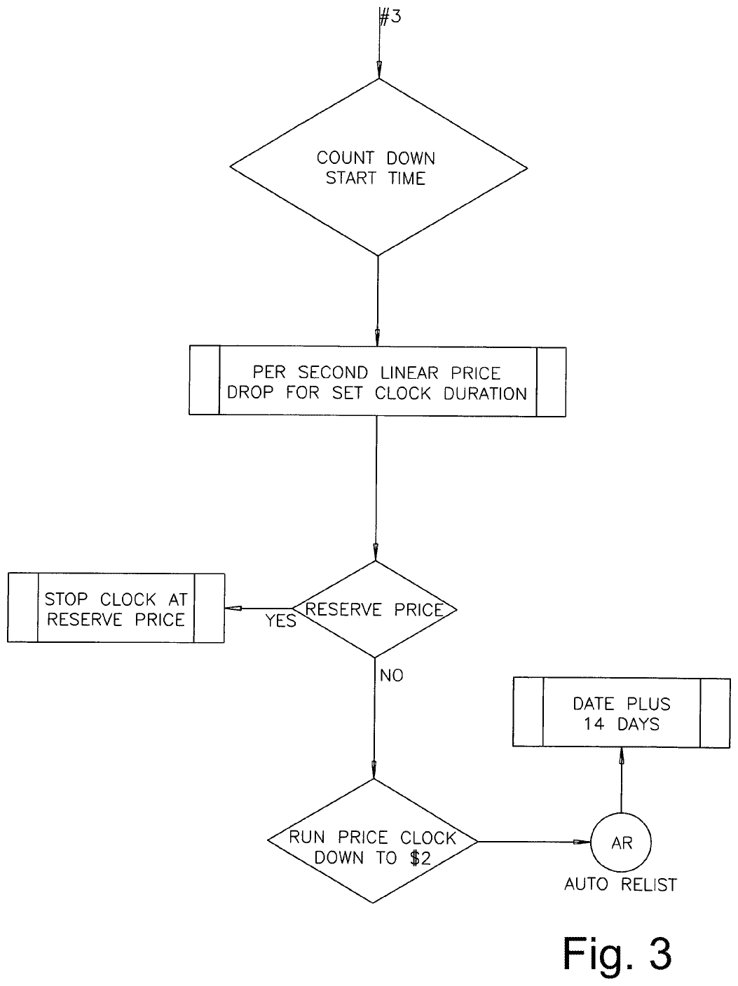

FIG. 3—(CDM-LD1 Sheet 3 of 4) is a Logic Flow Diagram—Item Price Count Down Control

This drawing depicts the control of the sales item abating price evolvement. These processes are automated and fully integrated into the overall system. Written in Python in a Django server-side web framework.

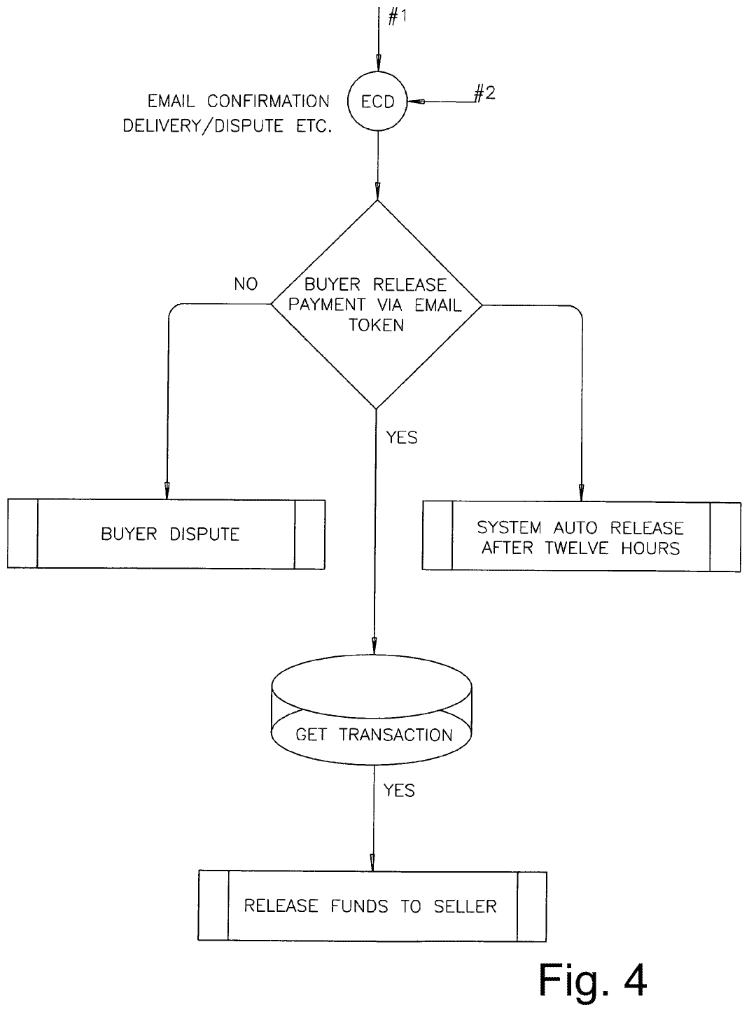

FIG. 4—(CDM-LD1 Sheet 4 of 4) is a Logic Flow Diagram—Escrow Payment Control

This drawing depicts the control of the escrow payment system. These processes are automated and fully integrated into the overall system. Written in Python in a Django server-side web framework.

My invention is a computer implemented system for conducting abating price evolvement (SAPE) escrow controlled electronic commerce transactions for a membership group on the Internet and contains the following components as detailed in the three claims below:

1. Firstly, my invention provides complete financial safety in internet commerce transactions by the automated escrow control of the Buyer's money, whereby the Buyer's funds are held by the system and not released until the purchased item is received in ‘As Described’ condition.

2. Secondly, my invention determines the price of the item for sale by first displaying the item in a graphical Showcase at a fixed price for a length of time and then lowering the price, using an abating price evolvement (SAPE) system, until an accredited member decides to buy, whereupon this single bid triggers the automated and integrated escrow system to take over and complete the transaction.

3. Thirdly, my invention houses the entire process of enrolling and vetting buyers and sellers (members), the information exchange between the system and its members, money management via escrow and the SAPE system, into a fully integrated software apparatus that operates on a stand alone basis, and at this time, is new and completely unique.
